(19) United States
(12) Patent Application Publication
(10) Pub. No.: US 2025/0346765 A1
(43) Pub. Date: Nov. 13, 2025

(54) BLACK ZINC PARTICLES; METHOD OF THEIR PRODUCTION AND USE

(71) Applicant: ECKART GMBH, Hartenstein (DE)

(72) Inventors: Guenter Kaupp, Neuhaus an der Pegnitz (DE); Juergen Hermann, Goldkronach (DE); Markus Drescher, Velden (DE); Lisa Siggelkow, Röthenbach (DE)

(21) Appl. No.: 18/871,535

(22) PCT Filed: Jun. 12, 2023
(86) PCT No.: PCT/EP2023/065585

§ 371 Date: Dec. 4, 2024

(30) Foreign Application Priority Data
Jun. 10, 2022 (EP) 22178396.2
Jul. 19, 2022 (EP) 22185696.6

(51) Int. Cl. C09C 1/00; C09C 1/02; C09C 1/04; C09C 3/00; C09C 3/04; C09C 3/06; C09D 5/08

(52) U.S. Cl. CPC C09C 1/0081; C09C 1/027; C09C 1/043; C09C 3/006; C09C 3/041; C09C 3/06; C09D 5/084; C01P 2004/03; C01P 2004/45; C01P 2004/51; C01P 2006/62

(57) ABSTRACT

This invention is directed to black particulate zinc composite comprising:
a) elemental zinc or zinc alloy in an amount c_{Zn,M} which is in a range of 58.0 to 85.0 wt. %, based on the weight of the composite,
b) Zn-oxide and
c) a further material, wherein the amount of the further material c) c_{add} is in a range of 4.5 to 17.0 wt. %, based on the weight of the composite,
and wherein components b) and c) are at least partially intermingled with the elemental zinc or zinc alloy metal a).

The black zinc particles are used as corrosion protection pigment. The particles are manufactured by a dry-milling process under harsh conditions in presence of an abrasion aid which is incorporated into the pigment during the milling step.

The present invention relates to black zinc particles which can be used in cathodic corrosion protection films.

Zinc powder is suitably used for industrial steel parts such as automobile parts and electric parts, and anticorrosion undercoat paints for protecting members such as buildings from corrosion. The resin layer containing zinc powder or zinc flakes acts as an anticorrosion layer that protects the steel material from rust by sacrificing zinc due to its electrochemical properties. The above-mentioned industrial steel parts like constructions of buildings and bridges and the like as well as automotive applications and especially screw coatings and building members may be required in some applications to have a black color tone as a dark color of natural harmony rather than a glaring plating color. In the painting of such members and especially screws mounted in a car vehicle, the most conventional method used is to apply a zinc powder or zinc flake paint as an undercoat paint, drying, and then a colored topcoat paint such as a black paint is applied and dried. Here, the black color of the anticorrosion paint with conventional black pigments is used. However, any scratch of the topcoat will be unfavorably contrasted as the zinc containing undercoat will appear grey to silvery. Therefore, black zinc pigments are needed to diminish this contrast.

There has been a demand for a paint that increases the degree of blackness and exhibits anticorrosion properties within a single coating. In response to such problems, various techniques for increasing the blackness of anticorrosion paints have been conventionally studied. For example, JP H0649393 A describes a black zinc powder coating composition obtained by blending 50 to 86 parts by weight of zinc powder and 1 to 10 parts by weight of conductive carbon black with respect to 100 parts by weight of a coating film-forming component containing a resin. In JP H0222125 A a zinc powder having an oxygen content of 1.0 wt % or less obtained by quenching zinc vapor is placed in an oxygen-containing atmosphere at a temperature of 80 to 400° C. and a pressure of 1 to 20 atm for a certain period. A method for obtaining zinc oxide powder for black pigment having an oxygen content of 2.5 to 18.0 wt % by oxidizing the surface is disclosed.

As described above, various methods for increasing the blackness of the zinc powder paint have been developed. However, for example, the method of mixing a pigment such as carbon black with zinc powder has the problem that the zinc content in the coating film is lowered and the anticorrosion performance is lowered. Further, the conventional method of blackening the color tone of the zinc powder itself is not sufficient in terms of blackness.

DE 10 2014105434 A1 disclosed a black zinc coating by combining zinc flakes with dark pigments of spinel type. Such solutions, however, are expensive to realize and to obtain real dark coatings quite a lot of the dark pigments are needed. These pigments, however, may hider electrical contact of the zinc flakes and therefor diminish electrical conductivity. Furthermore, the viscosity of pastes containing these mixtures can be difficult to be adjusted in proper regions which decreases flexibility of coating formulations.

Dark metal pigments were also disclosed in EP 2173819 A2 by coating a metal flake with a matrix material such as silica and dark pigments having low IR absorption. Such pigments, however, can hardly be used as corrosion protection pigment even when using zinc as metal flake and they are difficult and costly in their manufacture.

U.S. Pat. No. 7,021,573 B2 discloses a dry milling process of zinc powder using a fluoro carbon polymer. No black zinc particles are obtained herein.

WO 1999/9058274 A1 discloses a dry milling process using graphite particles as a solid lubricant in the absence of organic lubricants like long chained fatty acids. Flaky zinc pigments having high corrosion stability were reported to be obtained, however, no black zinc pigments.

WO 2021/216943 A1 discloses a black zinc pigment consisting of elemental zinc, zinc oxide and lubricants which can also be used in aqueous coatings. This document, however, does not disclose a detailed method how to manufacture such pigment. The same applicant has a product of black zinc pigments on the market (Blitz® Zinc Z2031), which however has a limited stability in salt spray tests.

JP 2020105575 A and JP 2021038331 A disclose a black zinc pigment obtained by wet grinding using branched fatty acids as lubricant. Such lubricants seem to enhance the oxidation of the zinc particles during milling. The particles are strongly overmilled using preferably a milling time of more than 200% of the milling time, where a maximum of the d₅₀-value of the particle size distribution of the zinc pigment is obtained. The final zinc pigments obtained are very fine and have a d₅₀-value of below of 6 μm. These pigments may cause safety issues when finally dried to a powder due to their small sizes. Additionally, they may cause viscosity problems when formulated into a coating formulation and thus limit the formulation versatility.

Complementary the same method as in these documents was disclosed in JP 2020105338 A, but the milling time was from 30% to below of 200% of the time of maximal d₅₀-value of the milled zinc pigment yielding larger zinc flakes which were, however, not black.

The object of the present invention is therefore to provide a black zinc pigment suitable for cathodic corrosion protection, especially passing salt spray tests and which has at least the blackness of present pigments of the state of the art but enhanced corrosion stability properties.

The object is solved by providing a black particulate composite comprising:
a) elemental zinc or zinc alloy in an amount c_{Zn,M} which is in a range of 58.0 to 85.0 wt. %, referred to the composite,
b) Zn-oxide and
c) a further material, wherein the amount of the further material c) c_{add} is in a range of 4.5 to 17.0 wt. %, referred to the total amount of the composite material, and wherein the further material c) is selected from the following groups:
   i) metal oxides or metal hydroxides selected from the group consisting of SiO₂, TiO₂, Al₂O₃, Al(OH)₃, magnetite, Fe₂O₃, ZrO₂ and mixtures thereof, or
   ii) silicates or aluminosilicates selected from the group consisting of synthetic mica, natural mica, preferably biotite or muscovite, nepheline-syenite, Zn-silicates and mixtures thereof;
   iii) metal phosphates,
   iv) BaSO₄ or mixtures of any of species i) to iv) thereof, and wherein components b) and c) are at least partially intermingled with the elemental zinc metal a).

Further preferred embodiments are disclosed in claims 2 to 12.

A further object is to provide a method of manufacture these pigments which is cheap.

This object was solved by providing a method of manufacture of the black composite material, comprising the steps:
a) providing a mixture comprising zinc powder, an abrasion aid, which is made from further material c) or a precursor thereof and a lubricating aid in a milling aggregate equipped with milling balls,
b) dry milling the mixture of a) for a time tm, wherein no fluorocarbon polymer is used during the milling process,
c) separating the milled mixture from the milling aggregate and
d) optionally further steps like particles sizing and/or pasting.

A further object was to provide a use of the black zinc pigment.

This object is solved by the use of the claimed black particulate composite as corrosion protection pigment in heavy corrosion protection formulations.

### DETAILED DESCRIPTION:

### Black Zinc Particulates

The inventive black particulate composite comprises:
a) elemental zinc or zinc alloy in an amount c_{Zn,M} which is in a range of 58.0 to 85.0 wt. %, referred to the composite,
b) Zn-oxide and
c) a further material, wherein the amount of the further material c) c_{add} is in a range of 4.5 to 17.0 wt. %, referred to the total amount of the composite material, and wherein the further material c) is selected from the following groups:
   i) metal oxides or metal hydroxides selected from the group consisting of SiO₂, TiO₂, Al₂O₃, Al(OH)₃, magnetite, Fe₂O₃, ZrO₂ and mixtures thereof, or
   ii) silicates or aluminosilicates selected from the group consisting of synthetic mica, natural mica, preferably biotite or muscovite, nepheline-syenite, Zn-silicates and mixtures thereof;
   iii) metal phosphates,
   iv) BaSO₄ or mixtures of any of species i) to iv) thereof,
   and wherein components b) and c) are at least partially intermingled with the elemental zinc metal a).

The black particulate composite has a rather unshaped form. It therefore differs from zinc flakes which are usually obtained by either dry or wet milling of zinc powder into flaky morphology.

The term “black” refers to a diffuse L*-value using D65/10° conditions of preferably <36.0, more preferably <35.0 and most preferably <34.0, measured on panels. The panels are made in the following way: 56.5 g of the black zinc composite is stirred into 43.5 g of a solvent-based silicate lacquer (having a solid content of about 55 wt %). Optionally the viscosity can be adjusted to a range of 30 s to 50 s measured with a flow cup according to DIN 53211 by adding dipropylene glycol (maximum up to 10 g) and this lacquer is applied by a draw-down, (nominal dry film applied: 24 μm, speed 3 cm/min) on a metal substrate (steel Q-Panel R46) using two runs applied in opposite directions. The panel is ventilated at 100° C. for about 30 min, and baked for 40 minutes in an oven at 300° C.

For the term “black particulate composite” also terms like “black zinc”, “black zinc pigment” are used interchangeably within this invention.

The zinc component can be either pure zinc or a zinc alloy. Preferably the zinc has a purity of 99.99 wt. % and more preferably a purity of 99.995 wt. %.

As a zinc alloy preferably an alloy of generic formula (I) is used:

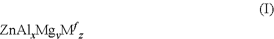

Herein x, y and z denote to the contents of the respective metal in wt.-%, referred to the total content of the alloy. x is in a range from >0 to 10, preferably in a range from 2.5 to 7; y is in a range from ≥0 to 7, preferably in a range from 0.5 to 6 and z is in a range from 0 to <2.5, preferably in a range from 0.01 to 0.5 and more preferably in a range of 0.02 to 0.1. Mf denotes to further optional alloy metals which can be treated as a sum and are preferably Ca, Sn, Si, In, Bi, Mn, K, Sr, Ba and mixtures thereof, and more preferably Ca, Sn, Si, In, Bi and mixtures thereof.

The balance of the alloy is made by zinc and unavoidable impurities.

Preferably the zinc alloy comprises a composition of 87.0 to 98.0 wt. % of zinc, 0.0 to 10.0 wt. %, preferably 2.0 to 8.0 wt. % of aluminum, and 0.0 to 6.0 mass % of magnesium mixtures thereof, each referred to the total amount of metals of the zinc alloy. In further preferred embodiments the proportion of Sn, Ca, Si, In, Bi, Mn, K, Sr, Ba and mixtures thereof is less than 0.3 wt. %, more preferably less than 0.1 wt. %, based in each case on the total amount of the zinc alloy. Any alloy and as well pure zinc-based particles may further contain naturally occurring inevitable impurities of the respective metal components.

The term C_{Zn,M} denotes to the amount of elemental zinc and optionally additional elemental alloy metals (M) which can be detected by volumetric titration. The volumetric titration is based on the reduction of Fe(III) to Fe(II) ions with concomitant oxidation of the elemental metal and the method is described in detail in the experimental section. The Fe(II) ions can be titrated by potassium permanganate or by cerimetry. In case of other metal alloy components M the alloy composition needs to be determined first (for example by X-ray diffraction) and then a correction of the titration results can be made assuming a uniform oxidation of all metal elements. The amount of elemental zinc C_{Zn,M} is in a range of 58.0 to 85.0 wt. %, in preferred embodiments in a range of 59.0 to 80.0 wt. % and in most preferred embodiments in a range of 60.0 to 78.0 wt. %, each referred to the composite.

Below of 58.0 wt.-% the amount is too low leading to insufficient corrosion behaviour and also a not long-lasting behaviour as sacrificial anode in the corrosion film. Above of 85.0 wt.-% the composites are not dark enough and also might cause safety issues because of the high amount of elemental metal and which is at least partly present in a very fine form and a correspondingly low amount of the respective metal oxides.

Without being bound to a theory it is assumed that the zinc or zinc alloy occurs at least partly as nanoparticles of average sizes of less than 60 nm, preferably less than 50 nm. Such metallic nanoparticles may be well embedded into zinc-oxide and/or the further material c). It is assumed that the existence of such nanoparticles is to a great part the reason for the black color of the composite particles.

The component b) Zn-oxide is in most cases originated by the oxidation of the zinc particles. The manufacture of these particles involves dry milling of zinc powder under harsh conditions which cause quite significant amount of zinc to oxidize. After the milling process the composite particles will come into contact with ambient atmosphere which usually causes further oxidation on the surface of the particles.

The term “Zn-oxide” stands here for the oxide ZnO, the hydroxide Zn(OH)₂ as well as for any mixture of Zn-oxide and-hydroxide species, wherein the formal oxidation state of zinc may be between (0) and (II) and preferably between (I) and (II). Especially on the surface of the black particulate zinc composite such mixed species may be evolved under the influence of oxygen and water during and after the milling process.

In case of zinc alloys other metal components like aluminum or magnesium might also partly be oxidized. The amount of these oxides may simply be estimated by first determining the amount c_{Zn,M} and the amount of further material c) and then subtracting these amounts from the total amount of black composite particle, possibly correcting for residuals of organic lubricants like fatty acids.

Another method of determining the amount of Zn-oxide involves the determination of the whole zinc (including possible alloy metals) content by titration of the black particulate composite in hydrochloric acid media with EDTA as described in paragraph [0063] of JP 2020105575 A, for example, and recalculating the amount of ZnO by subtracting the elemental metal content as determined by the Fe(II) oxidation (combined with permanganometry or cerimetry).

The amounts of component b) ZnO (and possibly other metal oxides stemming from alloy components) c_{ZnO,M-ox} are preferably in a range of 10.0 to 35.0 wt-%, more preferably in a range of 13.0 to 34.0 wt. % and most preferably in a range of 15.0 to 32.0 wt. %, each referred to the total amount of composite particle.

Some part of the Zn-oxide will be located onto the surface of the black zinc pigment while the other part is found inside the particle being intermingled at least partly to the elemental metal.

In preferred embodiments at least 30 atom-% of the total Zn-oxide content is found in the interior of the particle, more preferably at least 40 atom-% and most preferably at least 50 atom-%, referred to the total Zn-oxide content.

Such amounts may be determined by SEM (scanning electron microscopy) in combination with EDX (energy dispersive X-ray spectroscopy) of cross-sections of the black zinc particulates.

The further material c) was used as abrasion aid during this milling of zinc powder in a dry milling process.

The further material c) is a material of certain hardness as it is intended to be used as abrasion aid during the dry milling process. This further material preferably has a hardness according to the Mohs-scale of a range of more than 2.5 to about 9.5 and more preferably of a range of 4 to 7. The hardness values refer to the respective bulk materials. It's hardness must be higher than the hardness of elemental zinc (2.5) in order to abrade the zinc powder. However, the hardness should not be too high as the interior of the ball mill or the beads might adversely be affected or even been destroyed by this material.

The abrasion aid strongly deforms the zinc powder particles and can itself be either unchanged in its particle morphology or may be crushed into smaller pieces. In the final black zinc particulate this material will be intermingled with elemental zinc and may also be intermingled with the ZnO.

Preferably the further material c) is at least partially intermingled with the elemental zinc particles after the whole manufacturing process. The intermingled abrasion aid may be also detected by SEM in combination with EDX of cross-sections of the black zinc particulates. Intermingled particles will be found in the interior of such particulates.

Preferably at least 50 atom-%, more preferably at least 60 atom-%, even more preferably at least 70 atom-% and most preferably at least 80 atom-% of the abrasion aid are intermingled with the elemental zinc particles.

Only a small part of the abrasion aid can be found on the surface of the composite particulate after the milling process.

The further material c) does not form an enveloping coating layer or a coating of distinct particles on the zinc particles surface. Occasionally a particle of material c) may be present onto the surface of the zinc composite particulate, but preferably less than 20% of the mass of material c) is present in such form.

According to this invention the further material c) is selected from the groups consisting of
i) metal oxides or metal hydroxides such as SiO₂, TiO₂, Al₂O₃, Al(OH)₃, magnetite, Fe₂O₃, ZrO₂ and mixtures thereof, or
ii) silicates or aluminosilicates such as synthetic mica, natural mica, preferably biotite or muscovite, nepheline-syenite, Zn-silicates and mixtures thereof;
iii) metal phosphates,
iv) BaSO₄ or mixtures of any of species i) to iv) thereof.

The material c) should have a compact form like spheroidal, flaky or unshaped. A needle-like form should be avoided. Usually material c) is selected from inorganic metal oxide pigments, fillers or desiccants common in the coatings industry.

In a special embodiment material c) may be also comprise or consist of ZnO. These ZnO particles can also be mixed with any of the other materials c) mentioned above.

In most preferred embodiments the further material c) is SiO₂ or nepheline-syenite or mixtures thereof.

The further material c) may be surface modified and especially hydrophobized. Hydrophobization may be achieved by organofunctional silanes having alkyl or aryl moieties, for example.

Most preferred a hydrophobized SiO₂ or a hydrophobized nepheline-syenite or mixtures thereof is used as further material c).

Examples of organofunctional silanes which impart hydrophobization of further material c) are dimethyl dichlorosilane, trimethoxy-i-butylsilane, trimethoxy octylsilane, hexadecyl trimethoxysilane, octyl triethoxysilane, silazanes selected from 1,1,1-trimethyl-N-trimethylsilyl-silaneamine and N-methyl-aza-2,2,4-trimethyl sila cyclopentane or siloxanes selected from octamethyl tetracyclosiloxane, deca methylpenta cyclosiloxane or polydimethylsiloxane, and combinations thereof.

Examples of commercially available products for the further material c) are amorphous silica particles like Syloid Al 1 (Grace), amorphous or precipitated silica particles like Aerosil R 972 or Aerosil 9201, Sipernat D10, Sipernat D13 or Sipernat D14 from Evonik. Examples for nepheline-syenite are the Minex products from Sibelco (Belgium), or Silibond or Treminex products from Quarzwerke Group (Germany). Examples for BaSO₄ are Blanc Fixe N or G from Solvay. Examples for metal phosphates are Heucophos® products from Heubach (Germany) like a ZnCaSrAl orthophosphate silica hydrate such as ZCPPlus or a modified ortho zincphosphate like ZPO.

According to this invention the amount of the further material c) called c_{add} is in a range of 4.5 to 17.0 wt. %, and preferably in a range of more than 4.5 to 15.0 wt. %, more preferably in a range of 5.0 to 14.0 wt. %, and most preferably in a range of 6.0 to 13.0 wt. %, each referred to the total amount of the composite material. Suitable preferred ranges are also 6.0 to 17.0 wt. % and 7.0 to 17.0 wt. %, each referred to the total amount of the composite material.

Below of 4.5 wt. % the degree of blackness will be too low and above of 17 wt. % the corrosion protection will be too low, because the amount of active Zn will be too low.

The sum of the amounts of the abrasion aid additive c_{add} and the metal oxide c_{ZnO,M} is preferably in a range of 15.0 to 42.0 wt. %., more preferably in a range of 20.0 to 41.0 wt. % and most preferably in a range of 22.0 to 40.0 wt. %, each referred to the total amount of the black particulate zinc composite material.

The elemental content of zinc and optionally further metal alloy components c_{Zn,M} present in the compound represents the cathodic mass which is available when the pigment is used as sacrificial anode. However, due to the rather high specific surface of the pigments this cathodic mass is relatively easily accessible. This may be expressed by a parameter called the specific active Zn amount c_{Zn,M,spec.}, and is defined herein as c_{Zn,M.spec}=c_{Zn,M}/BET.

The term “BET” here is the specific surface measured by the well-known method based on Brunauer-Emmett-Teller (BET) theory and applying a 3-point measurement with nitrogen as adsorbing gas. Preferably c_{Zn,M.spec} is in a range of 14.0 to 87.0 wt. % x g/m², more preferably in a range of 15.0 to 87.0 wt. % x g/m² furthermore preferably in a range of 20.0 to 87.0 wt. % x g/m², even furthermore preferably in a range of 21.0 to 70.0 wt. % x g/m², and most preferably in a range of 23.0 to 65.0 wt. % x g/m².

The particle size can be determined by laser granulometry, preferably using a Malvern Mastersizer 2000 apparatus. As a measure of the mean diameter the median value d₅₀ can be used. The sizes are determined as volume weighted sphere equivalents according to the Fraunhofer approximation and according to the instructions of the manufacturer of the measurement instrument. Preferably the d₅₀ of the composite particles is in a range of 5.0 to 30 μm, more preferably in a range of 6.5 to 30 μm, even more preferably in a range of 7 to 30 μm, furthermore preferably in a range of 8 to 27 μm and most preferably in a range of 9 to 25 μm.

Below a d₅₀ of 5.0 μm the particles become too fine leading to safety issues when finally dried to a powder. Additionally, they may cause viscosity problems when formulated into a coating formulation and thus limit the formulation versatility of the corrosion pigments.

Above 30 μm particles are hardly accessible due to the harsh conditions of their manufacture.

### Method of Manufacture

A method of manufacture of the black zinc composite material, comprises the steps:
a) providing a mixture comprising zinc powder, an abrasion aid, which is made from further material c) and a lubricating aid in a milling aggregate equipped with milling balls,
b) dry milling the mixture of a) for a time tₘ, wherein no fluorocarbon polymer is used during the milling process,
c) separating the milled mixture from the milling aggregate and
d) optionally further steps like particles sizing and/or pasting.

In this process the zinc powder used has preferably an approximately spherical geometry. The zinc powder obtained after the atomization of the melt preferably have a median particle diameter d_{50,powder} within a range from 2 μm to 500 μm, further preferably from 5 μm to 200 μm, even further preferably from 10 μm to 100 μm. Preferably, the metal powder obtained by atomization has a narrow particle size distribution. It is preferable that the spherical metal particles of the alloy for use in accordance with the invention have a D₁₀ value of 1 μm to 15 μm, preferably of 1.0 to 10 μm, a D₅₀ value of 25 μm to 75 μm, preferably of 30 μm to 40 μm, and a D₉₀ value of 75 μm to 90 μm, preferably of 80 μm to 90 μm.

The dry-milling process is conducted under rather harsh conditions. The milling time tₘ of milling is preferably in a range of 12 to 36 hours, more preferably in a range of 13 to 30 hours, and most preferably in a range of 15 to 24 hours. These milling times are generally much longer than usual milling times used for the production of zinc flakes, for example.

Of key importance is the use of an additive as abrasion aid in the milling process. The abrasion aid is also called “abrasion aid additive” herein.

The abrasion aid facilitates the formation of very fine zinc or zinc alloy particles. These fine particles are supposed to be dark grey to black. Due to the harsh conditions of milling the abrasion aids may be comminuted also and finally are intermingled with the elemental zinc or zinc alloy. They also cause that less cold welding of the zinc powder particles to occur compared to normal milling of zinc powder without abrasion aid.

The milling process is preferably conducted under conditions of reduced oxygen content compared to ambient conditions. For example, the milling atmosphere may contain 3 to 15 vol. % of oxygen in an atmosphere of an inert gas like nitrogen or argon.

The zinc metal or zinc alloy metal components will be partly oxidized during the milling process. After the milling process the compound black pigment will come into further contact with oxygen or water under ambient conditions and a metal oxide will form on its surface. But part of the metal oxide formed during the milling process can be formed especially of small zinc particles and therefore will be also intermingled with the elemental zinc metal.

The median size of the abrasion aid particles used before milling d_{50,abrasion} is preferably in a range of 0.05 to 12 μm and more preferably in a range of 1.0 to 8.0 μm. These sizes refer to the primary particle size and not to aggregates which will anyhow be separated or crushed during the milling process. As the abrasion aid particles may be at least partly also being crushed the finally medium particles sizes are most likely smaller than the initial particle sizes.

Preferably the abrasion aid additive is used in an amount of 4.5 to 17.0 wt. % and more preferably of 6.0 to 13.0 wt.-%, each based on the amount of zinc powder. Below of 4.5 wt. % the particles formed are not black enough. If more than 17 wt. % are used the amount of elemental zinc or elemental alloy metals will be too low.

The abrasion aid is preferably selected from
i) the group consisting of metal oxides or metal hydroxides such as SiO₂, TiO₂, Al₂O₃, Al(OH)₃, magnetite, Fe₂O₃, ZrO₂ and mixtures thereof, or
ii) from silicates or aluminosilicates such as synthetic mica, natural mica, preferably biotite or muscovite, nepheline-syenite, Zn-silicates and mixtures thereof;
iii) metal phosphates,
iv) BaSO₄ or mixtures of any of species i) to iv) thereof.

Preferably the abrasion aid is at least partially intermingled with the elemental zinc particles after the whole manufacturing process. The intermingled abrasion aid may be detected by SEM (scanning electron microscopy) in combination with EDX (energy dispersive X-ray spectroscopy) of cross-sections of the black zinc particulates. Intermingled particles will be found in the interior of such particulates. Preferably at least 50 atom-%, more preferably at least 60 atom-%, even more preferably at least 70 atom-% and most preferably at least 80 atom-% of the abrasion aid are intermingled with the elemental zinc particles.

Only a small part of the abrasion aid can be found on the surface of the composite particulate after the milling process.

Further ingredients of the milling mixture are lubricants such as fatty acids. Preferably saturated fatty acids like stearic acid, oleic acid, linoleic acid, castor oleic acid, palmitic acid, arachidic acid, myristic acid, lauric acid, capric acid, elaidinic acid, erucic acid, linolenic acid, myristic acid, palmitoleic acid and mixtures thereof are used as lubricants. Most preferably saturated fatty acids like palmitic acid, stearic acid and mixtures thereof are used here.

It is preferred to use fatty acids with unbranched alkyl groups. In this case at least 90% of the fatty acids are unbranched while up to 10%, preferably up to 4% and most preferably up to 2% of the fatty acids may be branched.

The amount of these well-known lubricants is usually rather low in this manufacturing process and is preferably in a range of 0.1 to 3.0 wt.-%, more preferably in a range of 0.2 to 2.5 wt.-%, even more preferred in a range of 0.3 to 2.0 wt. % and most preferred in a range of 0.5 to 1.0 wt. %, each based on the total amount of zinc metal or zinc alloy and of the abrasion aid employed. Such low amounts favour the formation of a black composite zinc pigment, wherein the abrasion aid additive and partly also the formed metal oxides are intermingled with the elemental metal.

The dry milling process is used advantageously compared with a wet milling process because no solvent is used (avoidance of solvent emission) and the process is more energy efficient.

The milling aggregate is preferably any kind of grinding media mills such as a ball mill or an impact mill, a pin mill, blast mill, beater mill or attrition disk mill suitable for dry milling. Commercially such mills are available from Netzsch, Germany, for example. The milling balls of the ball mill are preferably made of steel and have a diameter of about 2.5 to about 6.0 mm. Below 2.5 mm the energy of milling is too low and above 6.0 mm the comminution of the zinc powder is not optimal.

The number of revolutions is preferably in a range of 55% to 75% relative to the critical number of revolutions norit, which can be determined according to the well-known formula:

$${n}_{crit} = \sqrt{\frac{g}{2 {π}^{2} * D}} \qquad ( II )$$

wherein D is the diameter of the drum and g the gravitation constant.

More preferably the number of revolutions is in the range of 60% to 70% relative to the critical number of revolutions.

Below of 55% the energy input into the grinding stock is too low and above of 75% the malleability becomes less optimal.

According to the invention no fluorocarbon polymer is used during the milling process. More particularly, no fluorocarbon polymer like PTFE is used as lubricant in the dry milling process. According to U.S. Pat. No. 7,023,572 B2 zinc flakes without black color can be produced by using fluorocarbon polymers as lubricant and a cooled ball mill.

The black particulate zinc composite can be used in heavy corrosion protection formulations, which are especially applicated for automotive and construction, especially for buildings and bridges and the like. Particularly preferred are dip-spin formulations which can be preferably used for coating of screws especially in automotive applications. Especially in automotive applications such formulations can be used to coat clips, washers, metal panels, screws, bolts, fasteners, brakes or automatic chassis components.

### Further Aspects

Furthermore in some embodiments the material c) comprises or consists of ZnO or Zn(OH)₂ or mixtures thereof. For these particular embodiments the invention has the following aspects:

A first aspect is directed to a black particulate zinc composite comprising:
a) elemental zinc or zinc alloy in an amount c_{Zn,M} which is in a range of 58.0 to 85.0 wt. %, referred to the composite,
b) Zn-oxides,
wherein component b) is at least partially intermingled with the zinc or zinc alloy metal a).

A second aspect according to this first aspect is directed to a black particulate zinc composite material, wherein the amount c_{Zn,M} is in a range of 60.0 to 75.0 wt. %, referred to the composite.

A third aspect according to any of the foregoing aspects is directed to a black particulate zinc composite wherein the specific active Zn amount c_{Zn,spec.}, defined as c_{Zn,spec}=c_{Zn}/BET, is in a range of 14.0 to 90 wt. % x g/m².

A fourth aspect according to any of the foregoing aspects is directed to a black particulate zinc composite material, wherein the specific active Zn amount c_{Zn,spec} is in a range of 25 to 87 wt. % x g/m².

A fifth aspect according to any of the foregoing aspects is directed to a black composite material, wherein component a) is a zinc alloy represented by the formula

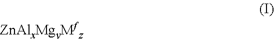

wherein x, y and z denote to the contents of the respective metal in wt.-%, referred to the total content of the alloy and wherein
x is in a range from >0 to 10, y is in a range from >0 to 7, and z is in a range from 0 to 0.5, and wherein Mf denotes to further metals which can be treated as a sum and are selected from the group consisting of Ca, Sn, Si, In, Bi, Mn, K, Sr, Ba and mixtures thereof.

A sixth aspect according to any of the foregoing aspects is directed to a black composite material, wherein at least 15 mol-% of the component b) of ZnO, Zn(OH)₂ or mixtures thereof is found in the composite interior, when analyzed in a cross-section with SEM and EDX.

A seventh aspect according to any of the foregoing aspects is directed to a black particulate zinc composite according to any of the previous claims, wherein the amount of b) Zn-oxides is in a range of 15.0 to 42.0 wt. %, referred to the total amount of the composite material.

An eighth aspect according to any of the foregoing aspects is directed to a black composite material, wherein at least part of the ZnO or Zn(OH)₂ was used as abrasion aid during milling of zinc powder in a dry milling process.

A nineth aspect is directed to a method of manufacture of the black composite material, comprising the steps:
a) providing a mixture comprising zinc powder or zinc alloy powder, an abrasion aid, which is made from ZnO, Zn(OH)₂ particles or mixtures thereof and a lubricating aid in a milling aggregate equipped with milling balls,
b) dry milling the mixture of a) for a time tₘ,
c) separating the milled mixture from the milling aggregate and
d) optionally further steps like particles sizing and/or pasting.

A tenth aspect according to aspect 9 is directed to a method of manufacture of the black composite material, wherein the abrasion aid is used in an amount of 4.5 to 17.0 wt. %, based on the amount of zinc powder.

An eleventh aspect according to aspect 9 or 10 is directed to a method of manufacture of the black composite material, wherein the median size of the abrasion aid d_{50,abrasion} is in a range of 0.05 to 12 pm.

A twelfth aspect according to any of aspects 9 to 11 is directed to a method of manufacture of the black composite material, wherein the milling time tm is in a range of 12 to 36 hours.

A thirteens aspect according to any of aspects 9 to 12 is directed to a method of manufacture of the black composite material, wherein the zinc alloy powder is represented by the formula

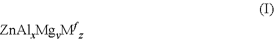

wherein x, y and z denote to the contents of the respective metal in wt.-%, referred to the total content of the alloy and wherein
x is in a range from >0 to 10, y is in a range from >0 to 7, and z is in a range from 0 to 0.5, and wherein M′ denotes to further metals which can be treated as a sum and are chosen from the group of Ca, Sn, Si, In, Bi, Mn, K, Sr, Ba and mixtures thereof.

### EXAMPLES

### Example 1

7 kg of steel balls (diameter: 4.7 mm), 180 g of zinc alloy 1 powder <140 μm, 20 g of an abrasion aid according to tables 1 and 2 and 1 g of stearic acid were introduced into a drum mill (length: 35 cm, width: 18 cm). The mixture was then dry ground at 60 rpm for 16 hours at a reduced oxygen content of 5%.

Subsequently, the product was saturated with increasing oxygen content for 2 h. Finally, the resulting black zinc composite product was carefully separated from the metal balls via a sieve.

### Example 2

7 kg of steel balls (diameter: 4.7 mm), 180 g of zinc alloy 1 powder <140 μm, 20 g of an abrasion aid according to tables 1 and 2 and 2 g of stearic acid were introduced into a drum mill (length: 35 cm, width: 18 cm). The mixture was then dry ground at 60 rpm for 16 hours at a reduced oxygen content of 5%.

Subsequently, the product was saturated with increasing oxygen content for 2 h. Then the resulting black zinc composite product was carefully separated from the metal balls via a sieve.

### Examples 3 to 24 and Comparative Examples 1 to 5

Further Examples were conducted according to Examples 1 or 2 but using experimental parameters as listed in table 1. In table 2 the abrasion aid additives used therein are specified into more details.

### Comparative Example 6

Competitor product Blitz® Zinc Z2031 of black zinc (Benda-Lutz from Sun Chemical).

### Initial Zinc Powders

Some of the inventive Examples used commercially available Standart® Zinc AS <45 μm (Eckart Suisse) as initial zinc powder as exemplified in table 1.

In other examples zinc alloys (called “zinc alloy 1 or 2” in table 1) having an approximately spherical geometry and obtained by atomizing in usual manner were used. The zinc alloy 1 had a composition of 94 wt % of zinc, 5 wt % of aluminum and 1 wt % of magnesium. Different fractions of this alloy were used as exemplified by the sieving or air classification parameters in table 1.

The zinc alloy 2 had a composition of 6 wt. % of aluminum and 6 wt. % of magnesium and a balance of zinc.

TABLE 1
Experimental parameters of the manufacture of Examples

| | | Amount | | |
|---|---|---|---|---|
| | | of Zn | Amount and | Milling |
| | | powder | kind of abrasion | time |
| Example | Zn powder | [g] | aid additive | [min] |
| Example 1 | Alloy 1 < 140 μm | 180 | 20 g additive #1 | 960 |
| Example 2 | Alloy 1 < 140 μm | 180 | 20 g additive #4 | 1000 |
| Example 3 | Standart ® Zinc | 180 | 20 g additive #1 | 960 |
| | AS < 45 μm | | | |
| Example 4 | Standart ® Zinc | 185 | 15 g additive #2 | 960 |
| | AS < 45 μm | | | |
| Example 5 | Standart ® Zinc | 180 | 10 g additive #1 + | 1200 |
| | AS < 45 μm | | 10 g additive #8 | |
| Example 6 | Standart ® Zinc | 180 | 20 g additive #3 | 960 |
| | AS < 45 μm | | | |
| Example 7 | Alloy 1 < 45 μm | 180 | 20 g additive #1 | 960 |
| Example 8 | Alloy 1 < 140 μm | 180 | 20 g additive #3 | 960 |
| Example 9* | Alloy 1 < 140 | 180 | 20 g additive #1 | 960 |
| Example 10 | Alloy 1 < 500 μm | 180 | 20 g additive #1 | 1080 |
| Example 11 | Alloy 1 < 500 μm | 180 | 20 g additive #4 | 1080 |
| Example 12 | Alloy 1 < 140 μm | 180 | 20 g additive #6 | 1200 |
| Example 13 | Alloy 1 < 140 μm | 180 | 20 g additive #4 | 1200 |
| Example 14 | Alloy 1 < 140 μm | 180 | 20 g additive #7 | 1200 |
| Example 15 | Alloy 1 < 140 μm | 180 | 20 g additive #1 | 1200 |
| Example 16 | Alloy 1 < 140 μm | 190 | 10 g additive #1 | 1200 |
| Example 17** | Alloy 1 < 140 μm | 185 | 15 g additive #1 | 1000 |
| Example 18** | Alloy 1 < 140 μm | 180 | 20 g additive #1 | 1000 |
| Example 19 | Alloy 1 < 140 μm | 180 | 20 g additive #5 | 1000 |
| Example 20 | Alloy 2 < 45 μm | 200 | 20 g additive #1 | 960 |
| Example 21 | Alloy 2 < 45 μm | 180 | 20 g additive #3 | 960 |
| Example 22 | Standart ® Zinc | 180 | 20 g additive #9 | 1440 |
| | AS < 45 μm | | | |
| Example 23 | Alloy 1 < 45 μm | 180 | 20 g additive 8 | 1440 |
| Example 24 | Standart ® Zinc | 175 | 25 g additive 8 | 960 |
| | AS < 45 μm | | | |
| Comp. | Standart ® Zinc | 180 | 20 g additive #10 | 960 |
| Example 1 | AS < 45 μm | | | |
| Comp. | Standart ® Zinc | 180 | 20 g additive #6 | 1200 |
| Example 2 | AS < 45 μm | | | |
| Comp. | Standart ® Zinc | 180 | 20 g additive #7 | 1200 |
| Example 3 | AS < 45 μm | | | |
| Comp. | Standart ® Zinc | 180 | 20 g additive #4 | 1200 |
| Example 4 | AS < 45 μm | | | |
| Comp. | Standart ® Zinc | 180 | 20 g additive #5 | 1200 |
| Example 5 | AS < 45 μm | | | |

*in this Example the oxygen content was 12 vol. % instead of 5 vol. %.
**in these Examples the ball size was 4 mm instead of 4.7 mm.

TABLE 2
Abrasion aid additives used for grinding Examples and Comparative Examples

| | | | | | | Powder |
|---|---|---|---|---|---|---|
| | # | | | | | particle |
| | Abrasion | | | | | size |
| Chemical | aid | Trade | | Substance | Surface | d_{50, powder} |
| class | Additive | name | Supplier | class | modified | [μm] |
| Silicates | 1 | Syloid Al 1 | Grace | amorphous | — | 6-7 |
| and | | | | silica | | |
| alumo- | 2 | Aerosil R | Evonik | amorphous | hydrophobized | 0.016 |
| silicates | | 972 | | silica | surface | |
| | | | | | (dimethyl- | |
| | | | | | dichlorsilane) | |
| | 3 | Aerosil | Evonik | amorphous | hydrophobized | — |
| | | 9200 | | silica | surface | |
| | 4 | Minex 4 | Sibelco | Nepheline- | — | 6.8 |
| | | | | syenite | | |
| | 5 | Minex 12 | Sibelco | Nepheline- | — | 1.5 |
| | | | | syenite | | |
| | 6 | Silibond | Quarzwerke | Nepheline- | methyl silane | 4 |
| | | 600 TST | GmbH | syenite | | |
| | 7 | Treminex | Quarzwerke | Nepheline- | methyl silane | 3 |
| | | 958- | GmbH | syenite | | |
| | | 700TST | | | | |
| Glass | 10 | Glassflake | Glassflake | Classified | — | 35 |
| | | GF 100M | Ltd. | calcium | | |
| | | | | aluminum | | |
| | | | | borosilicate | | |
| | | | | flakes | | |
| Metal | 8 | Zinc oxide | Sigma | Zinc oxide | — | — |
| oxides | | | Aldrich | | | |
| | 9 | TiO₂ R996 | Lomon | Titanium | ZrAl treated | 0.23 |
| | | | | dioxide | | |

### Characterization

The Examples and Comparative Examples were characterized with respect to their particle size and tested with various methods. The results thereof are depicted in table 3.

### Particle Size Measurement

Approx. 0.5 g of the black zinc pigments from the samples were dispersed in a Hydro 2000 G dispersion unit with isopropanol and then measured with the connected Malvern Mastersizer 2000 according to information of the manufacture and under ultrasound impact in the measurement chamber during the measurements. The particle size was determined according to the Fraunhofer approximation method based on volume weighted sizes of equivalent spheres. The median value d₅₀ was used as a measure of the average particle size.

### Panel Preparation for Corrosion Test & Color Measurement

56.5 g of the black pigment of the inventive Examples and of Comparative Examples were slowly stirred into 43.5 g of a solvent-based silicate lacquer having a solid content of about 55 wt % and then dispersed. Optionally the viscosity was adjusted to a range of 30 s to 50 s measured with a flow cup according to DIN 53211 by adding dipropylene glycol (maximum up to 10 g) and the lacquer was applied by a draw-down, (nominal dry film applied: 24 um, speed 3 cm/min) on a metal substrate (steel Q-Panel R46) using two runs applied in opposite directions. The panel was ventilated at 100° C. for about 30 min, then cooled down and put for 40 minutes into an oven at 300° C. After cooling down, the panels could be used for color measurement and the salt spray test.

### Salt Sprays Test

The painted metal sheets as described were now subjected to a salt spray test to investigate their resistance to rust in accordance with ASTM B117; ISO 9227 or ASTM G85. The red rust formation after 504 h was assessed as percentage of the whole exposed area. The test was passed when the red rust area was ≤1.5%. If the red rust area was ≤0.8 it was denoted as “++”, if the red rust area was between more than 0.8% and ≤1.5% it was denoted as “+”. If the red rust area was >1.5% and ≤10.0 it was denoted as “−” and if it was >10.0% it was denoted as “−−”.

### Color Measurement

The painted panels were also used for color measurement on a Konica Minolta 700d spectrophotometer. The diffuse L*-value was determined using D65/10° conditions. The 4 corners and the center point of each panel were measured in clockwise direction. 10 measurements are taken from each point and the mean value was calculated. A L* value of about 32 is comparable to the visual appearance of carbon black. Samples with a L*value <29.0 were denoted as “++”, samples with L*values ≥29.0 and <34.0 were denoted as “+” and samples with L*-values ≥34.0 did not satisfy the test and were denoted as “−”.

### Determination of Active Zinc Content (for Pure Zinc Compound)

The determination of active zinc content was made by volumetric titration. The zinc pigment sample was dispersed into a ferric sulfate solution thereby reducing Fe³⁺ions to Fe²⁺. These Fe²⁺ions were titrated with potassium permanganate solution (0.1 N).

In a first step the titer of potassium permanganate was determined. Therefore, approx. 0.5 g of Na-oxalate were weighted into 250 ml beaker, dissolved in distilled water and filled into a 250 ml volumetric flask up to the mark. Then 50 ml of this solution were pipetted into in an Erlenmeyer flask. A 25 ml burette was filled with potassium permanganate (0.1 N) and the zero point was adjusted. The Na-oxalate solution was heated under stirring to 50° C. and then titrated with the potassium permanganate solution. The volume needed here is V₁ in ml. The titer of K-permanganate solution was calculated as follows:

$$t = \frac{2 * weight in ( in mg )}{dilution factor * 5 * M ( Na2C2O4 ) * V 1 in ml * c ( nominal )} \qquad ( IIIa )$$

$$t = \frac{0.4 weight in ( in mg )}{5 * 134 \frac{g}{mol} * V 1 in ml * 0.02 mol / l} = 2.98 \times {10}^{- 2} / V 1 [ 1 / ml ] \qquad ( IIIb )$$

A blank test was carried out by placing 5 ml acetone in an Erlenmeyer flask and then adding 50 ml of ferrous sulphate solution followed by approx. 30 ml of sulfuric acid (30%). Then 2 or 3 drops potassium permanganate were added to this solution and swirled. If the permanganate color remains, the Fe-solution and acetone were free of defects.

For the determination of the zinc content 100 mg of the zinc sample were weighted into a 250 ml Erlenmeyer flask. To enable better dispersing of the zinc particles 5 ml of acetone were added and warmed up slightly. Then 50 ml ferric sulfate solution of appropriate concentration were added and slightly stirred until the solid is solved. After adding 30 ml of sulfuric acid (30%) the color turned slightly green. This solution was titrated with the potassium permanganate solution yielding a volume V2 in ml.

The active Zinc content is accordingly calculated to be:

$$Zn ( \% ) = \frac{M ( Zn ) * V 2 * t}{20} \qquad ( IVa )$$

$$cZn ( \% ) = \frac{65.405 g / mol * V 2 * t}{20} \qquad ( IVb )$$

For better reproducibility, the titration was repeated several times (2 to 3) and the results were averaged. In case of the utilization of zinc alloys containing Al and Mg the determination of the elemental metal content c,_{ZnM} had to be corrected by a correction factor k₁ defined as:

$${k}_{1} = {M}_{alloy} / {M}_{Zn} = \frac{100}{( 100 - x - y ) + \frac{3 {x M}_{Zn}}{2 {M}_{Al}} + \frac{{y M}_{Zn}}{{M}_{Mg}}} \qquad ( V )$$

Here M_{Zn}, M_{Al} and M_{Mg} are the respective molar masses, M_{alloy} is the effective molar mass of the alloy, x is the content in wt. % of Al and y is the content in wt. % of Mg of the zinc alloy.

This correction factor is based on the following assumptions: the particles are supposed to be homogeneous with respect to the elemental metal contents, there are no segregations of an alloy element, the oxidation during the milling process was homogeneous with respect to the metals and no shift of the composition during the titration occurred.

TABLE 3
Experimental data & results:

| | | | | Active | | |
|---|---|---|---|---|---|---|
| | | | | Zinc and | | |
| | Median | Color value | | alloy | | Salt |
| | particle | L* | | metals | specific | spray test |
| | size d₅₀ | (should | BET | c_{Zn, M} | Zinc | Area red |
| Sample | [μm] | be <34.0) | [m²/g} | [wt %] | surface | rust in % |
| Example 1 | 11.6 | 29.6 | 2.9 | 73.2 | 25.2 | 1.1 |
| | | + | | | | + |
| Example 2 | 14.5 | 23.6 | 2.41 | 66.2 | 27.5 | 0.5 |
| | | ++ | | | | ++ |
| Example 3 | 13.0 | 28.8 | 1.60 | 66.8 | 41.8 | 0.12 |
| | | ++ | | | | ++ |
| Example 4 | 20.4 | 32.1 | 1.2 | 74.0 | 61.7 | 0.4 |
| | | + | | | | ++ |
| Example 5 | 18.6 | 32.0 | 0.9 | 68.6 | 76.2 | 0.5 |
| | | + | | | | ++ |
| Example 6 | 16.8 | 29.0 | 1.8 | 72.3 | 40.2 | 0.5 |
| | | + | | | | ++ |
| Example 7 | 8.9 | 26.5 | 2.9 | 66.0 | 22.8 | s |
| | | ++ | | | | 0.5 |
| | | | | | | ++ |
| Example 8 | 12.7 | 24.7 | 3.1 | 70.1 | 22.6 | 0.5 |
| | | ++ | | | | ++ |
| Example 9 | 11.5 | 27.1 | 2.44 | 65.2 | 26.7 | 0.5 |
| | | ++ | | | | ++ |
| Example 10 | 14.4 | 26.9 | 1.55 | 62.2 | 40.2 | 0.5 |
| | | ++ | | | | ++ |
| Example 11 | 15.2 | 25.5 | 1.39 | 61.2 | 44.1 | 0.9 |
| | | ++ | | | | + |
| Example 12 | 11.9 | 24.2 | 1.79 | 60.9 | 34.0 | 1.1 |
| | | ++ | | | | + |
| Example 13 | 15.8 | 27.9 | 1.36 | 61.6 | 45.3 | 0.5 |
| | | ++ | | | | ++ |
| Example 14 | 13.42 | 22.4 | 1.96 | 61.0 | 31.1 | 0.5 |
| | | ++ | | | | ++ |
| Example 15 | 11.6 | 25.8 | 2.37 | 60.9 | 25.7 | 1.4 |
| | | ++ | | | | + |
| Example 16 | 16.2 | 26.8 | 1.57 | 64.3 | 41.0 | 0.5 |
| | | ++ | | | | ++ |
| Example 17 | 14.6 | 28.6 | 2.37 | 66.1 | 27.9 | 0.5 |
| | | ++ | | | | ++ |
| Example 18 | 11.8 | 27.7 | 2.93 | 65.3 | 22.3 | 0.5 |
| | | ++ | | | | ++ |
| Example 19 | 12.9 | 24.1 | 2.4 | 62.0 | 25.7 | 1.1 |
| | | ++ | | | | + |
| Example 20 | 10.2 | 29.0 | 2.2 | 71.9 | 32.7 | 0.5 |
| | | + | | | | ++ |
| Example 21 | 13.9 | 27.9 | 2.4 | 71.4 | 29.7 | 0.5 |
| | | ++ | | | | ++ |
| Example 22 | 25.4 | 30.8 | 1.0 | 65.0 | 65.0 | 0.5 |
| | | ++ | | | | ++ |
| Example 23 | 18.7 | 27.7 | 1.6 | 60.0 | 37.5 | 0.5 |
| | | ++ | | | | ++ |
| Example 24 | 20.3 | 32.7 | 0.7 | 59.8 | 85.4 | 0.4 |
| | | + | | | | ++ |
| Comp. | 22.4 | 34.04 | 0.8 | 68.7 | 85.9 | 1.9 |
| Example 1 | | − | | | | − |
| Comp. | 13.3 | 22.8 | 1.25 | 54.6 | 43.7 | 32.5 |
| Example 2 | | ++ | | | | −− |
| Comp. | 13.4 | 24.1 | 1.25 | 55.1 | 44.1 | 23.7 |
| Example 3 | | ++ | | | | −− |
| Comp. | 12.2 | 27.1 | 1.57 | 52.7 | 33.6 | 18 |
| Example 4 | | ++ | | | | −− |
| Comp. | 11.1 | 28.1 | 1.57 | 53 | 33.8 | 18 |
| Example 5 | | ++ | | | | −− |
| Comp. | 10.2 | 32.0 | 2.8 | 68.2 | 24.4 | 4.1 |
| Example 6 | | + | | | | − |

### List of Figures

FIG. 1: Comparison photographs of salt spray test panels after 504 h:
upper row: Comparative Example 6, lower row: Example 2. The three panels for each sample were located at different sites in the salt spray chamber and therefore differ slightly.

FIG. 2: SEM micrograph of cross-section of pigment of Example 3 with magnification factor 10,000.

### Discussion:

All zinc pigment samples of the inventive Examples 1 to 24 were sufficiently dark enough (L*<34.0) and passed the salt spray test. The commercial Comparative Example 6 was also of sufficient darkness, but did not pass the salt spray test which can be also seen in FIG. 1. It can be well seen that at any of the depicted times the panels of Example 2 are much smoother compared to the panels of Comp. Example 6, where the red rust areas appear dark (“holes”) in this black/white photograph.

But further differences could be seen: the pigments of Comparative Example 1 wherein glass flakes were used as abrasion aid were not black enough and didn't pass the salt spray test. All other Comparative Examples were black enough but didn't pass the salt spray test. Particularly Comparative Examples 2 to 5 were conducted using a pure zinc powder, various additives and rather high milling times of 1200 min. The active zinc contents of these samples were rather low. Compared to these experiments Examples 12 to 14 were conducted under comparable conditions but using a zinc alloy. These results seem to show that the zinc alloy is favorable compared to pure zinc.

Generally, all Examples using silica or nepheline-syenite compounds as abrasion aid revealed excellent results. ZnO or TiO₂ particles can also be used well as abrasion aid, but either higher milling times should be used here (Examples 22 and 23) or higher concentrations (Example 24).

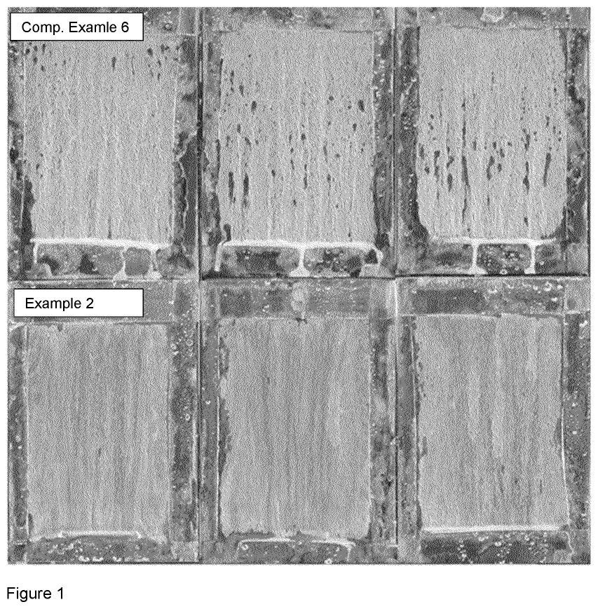

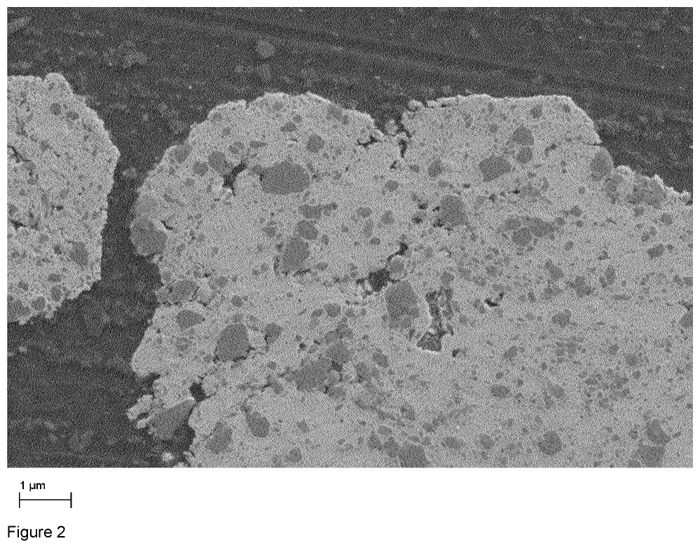

In FIG. 2 the inner structure of the pigment of Example 3 can be seen in a SEM cross-section micrograph. The silica particles used as abrasion aid here appear as dark contrast to the zinc or zinc oxide. It can be well seen that most of the silica particles are located in the inner pigment and are thus intermingled with the zinc and zinc oxide.

1. Black particulate zinc composite comprising:
a) elemental zinc or zinc alloy in an amount c_{Zn,M} which is in a range of 58.0 to 85.0 wt. %, based on the weight of the composite,
b) Zn-oxide and
c) a further material, wherein the amount of the further material c) c_{add} is in a range of 4.5 to 17.0 wt. %, based on the weight of the composite, and wherein the further material c) is selected from the following groups:
i) metal oxides or metal hydroxides selected from the group consisting of SiO₂, TiO₂, Al₂O₃, Al(OH)₃, magnetite, Fe₂O₃, ZrO₂ and mixtures thereof, or
ii) silicates or aluminosilicates selected from the group consisting of synthetic mica, natural mica, preferably biotite or muscovite, nepheline-syenite, Zn-silicates and mixtures thereof;
iii) metal phosphates,
iv) BaSO₄ or mixtures of any species of i) to iv) thereof,
and wherein components b) and c) are at least partially intermingled with the elemental zinc or zinc alloy metal a).

2. (canceled)

3. Black particulate zinc composite according to claim 1, wherein the further material c) is SiO₂ or nepheline-syenite or mixtures thereof.

4. Black particulate zinc composite according to claim 1, wherein the further material c), is further hydrophobized.

5. Black particulate zinc composite according to claim 1, wherein the amount of the further material c) is in a range of 6.0 to 17.0 wt. %, based on the weight of the material.

6. Black particulate zinc composite according to claim 1, wherein c_{Zn,M} is in a range of 59.0 to 80.0 wt. %.

7. Black particulate zinc composite according to claim 1, wherein the amount of b) Zn-oxide and of the further material c) together is in a range of 15.0 to 42.0 wt. %, based on the weight of the composite.

8. Black particulate zinc composite according to claim 1, wherein a specific active Zn amount c_{Zn,spec.},
defined as c_{Zn,spec}=c_{Zn}/BET
is in a range of 14.0 to 87.0 wt. % x g/m².

9. Black particulate zinc composite according to claim 1, wherein the further material c) does not form a coating layer or a coating of distinct particles on a surface of particulates of the black zinc composite.

10. Black particulate zinc composite according to claim 1, wherein the d₅₀ is in a range of 6.5 to 30 μm.

11. Black particulate zinc composite according to claim 1, wherein component a) is a zinc alloy represented by the formula 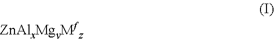
wherein x, y and z denote to the contents of the respective metal in wt.-%, based on the total content of the alloy and wherein
x is in a range from >0 to 10, y is in a range from >0 to 7, and z is in a range from 0 to 0.5, and wherein M^{f} denotes further metals which can be treated as a sum and are selected from the group consisting of Ca, Sn, Si, In, Bi, Mn, K, Sr, Ba and mixtures thereof.

12. Black particulate zinc composite according to claim 1, wherein the further material c) was used as an abrasion aid during milling of zinc powder in a dry milling process.

13. Black particulate zinc composite according to claim 1, wherein the composite exhibits a L*value of <34.0.

14. Method of manufacture of the black zinc composite according to claim 1, comprising the steps:
a) providing a mixture comprising zinc powder or zinc alloy powder, an abrasion aid, which is made from further material c) and a lubricating aid in a milling aggregate equipped with milling balls,
b) dry milling the mixture of a) for a time tm, wherein no fluorocarbon polymer is used during the milling process,
c) separating the milled mixture from the milling aggregate and
d) optionally further steps like particles sizing and/or pasting.

15. Method according to claim 14, wherein the abrasion aid is selected from the following groups:
i) metal oxides or metal hydroxides selected from the group consisting of SiO₂, TiO₂, Al₂O₃, Al(OH)₃, magnetite, Fe₂O₃, ZrO₂ and mixtures thereof, or
ii) silicates or alumosilicates selected from the group consisting of synthetic mica, natural mica, preferably biotite or muscovite, nepheline-syenite, Zn-silicates and mixtures thereof;
iii) metal phosphates,
iv) BaSO₄ or mixtures of any of species i) to iv) thereof.

16. (canceled)

17. A method of providing corrosion protection comprising applying a heavy corrosion protection formulation to an item wherein the heavy corrosion protection formulation comprises the black particulate zinc composite of claim 1.
